(19) United States
(12) Patent Application Publication
(10) Pub. No.: US 2024/0128505 A1
(43) Pub. Date: Apr. 18, 2024

(54) ANODE FOR ELECTRICAL ENERGY STORAGE

(71) Applicants: THE REGENTS OF THE UNIVERSITY OF CALIFORNIA, OAKLAND, CA (US); UCHICAGO ARGONNE, LLC, CHICAGO, IL (US)

(72) Inventors: Vincent LAVALLO, Riverside, CA (US); Anton TOMICH, Riverside, CA (US); Christopher S. JOHNSON, Argonne, IL (US); Lei CHENG, Naperville, IL (US); Eungje LEE, Lemont, IL (US); Jehee PARK, Woodridge, IL (US); Jihyeon GIM, Naperville, IL (US); Ethan Phillip KAMPHAUS, Chicago, IL (US)

(73) Assignees: THE REGENTS OF THE UNIVERSITY OF CALIFORNIA, OAKLAND, CA (US); UCHICAGO ARGONNE, LLC, CHICAGO, IL (US)

(21) Appl. No.: 18/488,971

(22) Filed: Oct. 17, 2023

Related U.S. Application Data
(60) Provisional application No. 63/380,025, filed on Oct. 18, 2022.

(51) Int. Cl. H01M 10/0565; H01M 4/04; H01M 4/38; H01M 10/0568; H01M 10/0569; H01M 10/26

(52) U.S. Cl. CPC H01M 10/0565; H01M 4/044; H01M 4/381; H01M 10/0568; H01M 10/0569; H01M 10/26; H01M 2004/027

(57) ABSTRACT

An anode in an electrochemical cell includes an anode active material comprising sodium and a solid electrolyte interphase (SEI) layer disposed on the anode active material. The SEI layer includes reduction products of an electrolyte solvent and is free of degradation products derived from dissolved anions of an electrolyte salt. The electrolyte solvent and the electrolyte salt are present in an electrolyte of the electrochemical cell. The SEI layer does not include a fluorine content greater than 5 wt. %.

### GOVERNMENT RIGHTS

This invention was supported by the U.S. Department of Energy, Office of Science, Office of Workforce Development for Teachers and Scientists, Office of Science Graduate Student Research (SCGSR) program. The SCGSR program is administered by the Oak Ridge Institute for Science and Education (ORISE) for the DOE. ORISE is managed by ORAU under contract number DE-SC0014664. Additionally, this invention was supported by the Advanced Battery Materials Research (BMR) Program of the U.S. Department of Energy (DOE), Office of Energy Efficiency and Renewable Energy, and Argonne, a U.S. Department of Energy Office of Science Laboratory, which is operated under Contract No. DE-ACO2-06CH11357. This invention was made with government support under DMR-2004497 awarded by the National Science Foundation (NSF). This invention was supported as part of the Joint Center for Energy Storage Research, an Energy Innovation Hub funded by the U.S. Department of Energy, Office of Science, Basic Energy Sciences. This invention used resources of the Advanced Photon Source, a U.S. Department of Energy (DOE) Office of Science User Facility operated for the DOE Office of Science by Argonne National Laboratory under Contract No. ACO2-06CH11357. The U.S. Government has certain rights in the invention.

### FIELD

The present technology is generally related to rechargeable electrochemical cells, and more specifically is related to electrolytes with carboranyl salts and solid-electrolyte interphases formed on anodes in the presence of these electrolytes.

### BACKGROUND

The energy crisis is a global challenge. In recent years, attention has been garnered by electrochemical energy storage that uses earth-abundant resources to realize sustainable and cost-effective alternatives to lithium-ion batteries (LIBs).

Sodium Ion Batteries (SIBS) are promising electrochemical systems. Sodium is abundant in the earth's crust at >2% crustal abundance. Consequently, soda ash (Na₂CO₃), from which electrode materials may be derived, has a lower cost than lithium. While SIBs are an exciting prospect, challenges have prevented their widespread commercial adoption. Challenges include the surface reactivity of sodium with conventional battery electrolytes and the instability of the solid electrolyte interphase (SEI) formed on the anode. These challenges result in several performance issues, including shorter battery lifespans and increased battery self-discharge.

### SUMMARY

To address the performance issues of SIBs, disclosed herein are electrolytes including carboranyl salts for rechargeable electrochemical cells that improve formation of the solid-electrolyte interphases (SEIs) formed on anodes in the presence of these electrolytes.

In one aspect, an anode in an electrochemical cell is disclosed. The anode includes an anode active material comprising sodium and a solid electrolyte interphase (SEI) layer disposed on the anode active material. The SEI layer includes reduction products of an electrolyte solvent. The SEI layer is free of degradation products derived from dissolved anions of an electrolyte salt. The electrolyte solvent and the electrolyte salt are present in an electrolyte of the electrochemical cell. The SEI layer does not include a fluorine content greater than 5 wt. %.

In some embodiments, the SEI layer may include species with bonding type Na—O, C—H, C—O, C—C, or a mixture of two or more thereof. The SEI layer may not include a fluorine content greater than 5 wt. %. The sodium in the anode active material may be present as a plurality of microparticles having widths of about 0.1 μm to about 10 μm.

In some embodiments, the electrolyte salt may include a carboranyl anion. The carboranyl anion may not include a C—C bond. The carboranyl anion may include HCB₁₁H₁₁⁻. The electrolyte solvent may include diglyme, triglyme, tetraglyme, 1,2-dimethoxyethane, 1,3-dioxolane, dimethyl carbonate, ethyl methyl carbonate, diethyl carbonate, ethylene carbonate, propylene carbonate, tetrahydrofuran, or a mixture of two or more thereof.

In another aspect, an electrochemical cell is disclosed. The electrochemical cell includes an anode including sodium and an electrolyte. The electrolyte includes a solvent and a carboranyl salt. The carboranyl salt does not include a C—C bond.

In some embodiments, the electrochemical cell may further include a solid electrolyte interphase (SEI) layer disposed on the sodium. The SEI layer may include species with bonding type Na—O, C—H, C—O, C—C, or a mixture of two or more thereof. The SEI layer may not include a fluorine content greater than 5 wt. %. The carboranyl salt may include HCB₁₁H₁₁⁻. The carboranyl salt may be present in the electrolyte in a concentration of about 0.1 M to about 4 M. The electrolyte may be free of fluorine. The solvent may include diglyme, triglyme, tetraglyme, 1,2-dimethoxyethane, 1,3-dioxolane, dimethyl carbonate, ethyl methyl carbonate, diethyl carbonate, ethylene carbonate, propylene carbonate, tetrahydrofuran, or a mixture of two or more thereof.

In some embodiments, the electrochemical cell may further include an anode current collector. The sodium may be present in the anode as a plurality of microparticles disposed on the anode current collector. The microparticles may have widths of about 0.1 μm to about 10 μm.

In another aspect, a method of fabricating an anode is disclosed. The method includes plating sodium metal on an anode current collector via electrodeposition from an electrolyte comprising a carboranyl salt dissolved in an organic electrolyte solvent. The method also includes forming a solid electrolyte interphase (SEI) on a surface of the sodium metal via electrochemical decomposition of the organic electrolyte solvent. Forming the SEI does not include electrochemical decomposition of the anion of the carboranyl salt.

In some embodiments, the anion of the carboranyl salt may not include a C—C bond. The anion of the carboranyl salt may include HCB₁₁H₁₁⁻. The carboranyl salt may be present in the electrolyte in a concentration of about 0.1 M to about 4 M. The electrolyte may be free of fluorine.

### BRIEF DESCRIPTION OF THE DRAWINGS

FIG. 1A is an illustration of the synthesis of and preparation of NaHCB₁₁H₁₁ via deprotonation of HNMe₃⁺¹ with NaH.

FIG. 1B is an illustration of the molecular structure of NaHCB₁₁H₁₁ dissolved in diglyme as determined by single crystal X-ray diffraction analysis (with hydrogen omitted for clarity).

FIG. 1C is a graph of synchrotron small angle X-ray scattering (SAXS) spectra characterizing in-situ anion-anion separation and the presence of anion clusters in NaHCB₁₁H₁₁ dissolved in diglyme (labelled (“Na1/G2”).

FIG. 1D is a simulation of [HCB₁₁H₁₁]⁻ anion dispersion in diglyme using molecular dynamics.

FIG. 1E is an enlarged image showing a simulation of anion-anion separation in NaHCB₁₁H₁₁ dissolved in diglyme using molecular dynamics.

FIG. 2 is a graph of galvanostatic cycling of Na—Na symmetrical cells assembled with NaHCB₁₁H₁₁ dissolved in diglyme electrolyte at varying current densities and 1.0 mAh cm⁻² areal capacity. Inset 210 displays early cycle life voltage hysteresis and inset 220 displays voltage hysteresis beyond 450 cycles.

FIG. 3A is a graph of Coulombic efficiency (CE) of a Na—Cu half cell operated with NaHCB₁₁H₁₁ dissolved in diglyme electrolyte over 300 cycles. The inset 310 is a picture of the anode current collector from a disassembled Na—Cu half cell displaying a pristine Cu electrode. The inset 320 is a picture of the anode current collector from a disassembled Na—Cu half cell after 1.0 mAh cm⁻² Na deposition on the Cu current collector substrate. The insets 330 and 340 show corresponding SEM images of the pristine and Na deposited electrode surfaces, respectively.

FIG. 3B is a graph of the voltage profile of a Na—Cu half cell using NaHCB₁₁H₁₁ dissolved in diglyme electrolyte cycled at a current density of 0.5 mA cm⁻², 1.0 mAh cm⁻² areal capacity.

FIG. 3C is a graph comparing Na—Al half-cell performance using 0.9 M NaHCB₁₁H₁₁ dissolved in diglyme electrolyte (labelled “Na1/G2”) and 1.0 M NaPF₆ dissolved in diglyme (labelled “NaPF₆/G2”).

FIG. 3D is a graph of voltage profiles of Na—Al half cells containing NaHCB₁₁H₁₁ dissolved in diglyme electrolyte (labelled “Na1/G2”) and 1.0 M NaPF₆ dissolved in diglyme (labelled “NaPF₆/G2”).

FIGS. 4A-4C are SEM images of Na—Cu half cells at progressive states of charge. FIG. 4A is at 0% state of charge (SOC). FIG. 4B is at 20% SOC. FIG. 4C is at 100% SOC.

FIG. 4D shows graphs of multinuclear X-ray photoelectron spectroscopy (XPS) spectra of sodium metal anodes retrieved from disassembled Na—Cu half-cell displaying relative abundance of species in the SEI layer at the surface of the anode.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

Overview

Sodium metal anodes are poised to provide energetically dense sodium metal batteries (SMBs), however they face a number of challenges to their commercial realization related to electrolyte compatibility and anodic interfacial phenomena. Unlike lithium metal anodes, the solid electrolyte interphase (SEI) of the sodium metal anode displays dynamic and unreliable behavior at its interface when traditional cyclic and linear carbonate electrolytes are employed. Spontaneous chemical reduction of these electrolytes results in unstable passivating films which repeatedly expose the anode to the bulk electrolyte solution, thereby accelerating device failure via consumption of active materials. Similarly to lithium, sodium metal anodes also exhibit dendritic nucleation morphologies which preclude long-term cycling stability. In addition to the intrinsic reactivity of sodium metal in the presence of moisture, these dendrites introduce safety concerns related to spontaneous short-circuit of the cell. Nevertheless, sodium metal anodes, whose low reduction potential and high theoretical capacity (−2.71 V vs. S.H.E., 1166 mAh g⁻¹) far exceed that of carbonaceous anodes, may realize low-cost energy storage that does not compromise current performance standards.

A number of approaches aimed at accommodating sodium metal anodes have been explored including solid-state electrolytes, liquid electrolyte additives, and ex-situ surface engineering techniques. These strategies have been implemented to prevent dendrite propagation, promote favorable SEI film composition, or directly tune the interfacial properties of the anode. In an effort to achieve even greater energy density and alleviate the processing hazards of sodium metal, some of these strategies aimed to generate the sodium metal anode in-situ in an “anode-free” cell architecture. However, these previous efforts typically included dramatic changes to current manufacturing infrastructure or lacked competitive performance characteristics to be considered commercially viable. Recently, non-fluorinated glyme-based electrolytes were explored for use in SIBS, but these electrolytes used fluorinated weakly coordinating anions (WCAs) such as NaPF₆. These anions are prone to severe decomposition in the presence of trace water impurities and elevated temperatures, and provoke safety concerns due to potential expulsion of toxic fluorinated compounds upon battery failure.

Disclosed herein are electrolytes including carboranyl salts for rechargeable electrochemical cells that improve formation of the solid-electrolyte interphases (SEIs) on anodes in the presence of these electrolytes and promote stable extended electrochemical cycling. Also disclosed are electrochemical cells including these electrolytes, and methods of making and using the same. In some embodiments, the anodes in the electrochemical cells may include anode active materials in their elemental form (e.g., the metallic form of lithium, sodium, and/or magnesium; and/or metalloid form of silicon).

The carboranyl salts used in the electrolytes may include boron-rich nanocluster (BRN) anions. BRNs are weakly coordinating anions. They are thermally, chemically, and electrochemically stable. In any embodiment, the BRN may include only one carbon atom. In other words, the BRN may not include any C—C bonds, since C—C bonds may break more easily than B-B bonds and B-C bonds, thereby lending stability to the BRN and mitigating or preventing BRN decomposition. In these embodiments, the BRN may feature one vertex where B is replaced with a carbon nuclei.

For example, the carboranyl salt may include the carboranyl anion HCB₁₁H₁₁⁻. The HCB₁₁H₁₁⁻ carborane anion is a BRN with icosahedral geometry that features one vertex replaced with a carbon nuclei. The weakly coordinating properties exhibited by HCB₁₁H₁₁⁻ may arise, without being bound by any theory, from the electron-deficient bonding motif between the boron and carbon vertices in the anion's icosahedral geometry, delocalized charge, and three-dimensional aromatic character. The HCB₁₁H₁₁⁻ carborane anion has a large HOMO-LUMO gap, which may contribute to its exceeding chemical stability. Furthermore, the HCB₁₁H₁₁⁻ carborane anion is non-corrosive, non-toxic, and does not decompose into deleterious biproducts in the electrochemical environment.

The solvent in the electrolyte may be an organic solvent. For example, the solvent may include diglyme, triglyme, tetraglyme, 1,2-dimethoxyethane, 1,3-dioxolane, dimethyl carbonate, ethyl methyl carbonate, diethyl carbonate, ethylene carbonate, propylene carbonate, tetrahydrofuran, or a mixture of two or more thereof.

In any embodiment, the organic solvent may be free of any fluorine species. Reducing or excluding fluorine species may provide longer cycling life and coulombic efficiency by mitigating or eliminating deleterious side-reactions involving the fluorine species and unstable SEI components. For example, the electrolyte may be free of conventional fluorine additives, including fluoroethylene carbonate (FEC). In some embodiments, the solvent may include less than 5 wt. %, less than 4.5 wt. %, less than 4.0 wt. %, less than 3.5 wt. %, less than 3.0 wt. %, less than 2.5 wt. %, less than 2.0 wt. %, less than 1.5 wt. %, less than 1.0 wt. %, less than 0.5 wt. %, less than 0.4 wt. %, less than 0.3 wt. %, less than 0.2 wt. %, less than 0.1 wt. %, less than 0.05 wt. %, or less than 0.01 wt. % of fluorine species relative to a total weight of the electrolyte.

Anodes

In one aspect, an anode is provide for an electrochemical cell, where the anode an SEI layer made of reduction products of the electrolyte solvent and is free of or substantially free of degradation products derived from dissolved anions of the electrolyte salt. The electrolyte solvent and the electrolyte salt are present in the electrochemical cell's electrolyte.

In another aspect, an anode in an electrochemical cell is provided, where the anode includes a metal or a metalloid of a main group element (“M”) that contains an SEI layer made of reduction products of the electrolyte solvent and is free of or substantially free of degradation products derived from dissolved anions of the electrolyte salt. The electrolyte solvent and the electrolyte salt are present in the electrochemical cell's electrolyte.

In another aspect, an anode in an electrochemical cell is provided, where the anode includes a metal or a metalloid M selected from the group consisting of Na, Li, Ca, Mg, and Si. The anode contains an SEI layer made of reduction products of the electrolyte solvent and is free of or substantially free of degradation products derived from dissolved anions of an electrolyte salt. The electrolyte solvent and the electrolyte salt are present in the electrochemical cell's electrolyte.

In another aspect, an electrolyte salt is included, the salt include cations and anions, wherein the anions do not decompose chemically/electrochemically to create degradation products that would be incorporated into an SEI layer.

In another aspect, an anode in an electrochemical cell is provided, where the anode includes (i) a metal or a metalloid M, which is selected from the group consisting of Na, Li, Ca, Mg, and Si; (ii) an electrolyte comprising an electrolyte salt and an electrolyte solvent; and (iii) an SEI layer disposed on a surface of the anode. The electrolyte salt is a carboranyl salt. The SEI layer comprises reduction products obtained by electrochemical reduction of the electrolyte solvent.

In another aspect, an anode in an electrochemical cell is provided, where the anode includes (i) a metal or a metalloid M, which is selected from the group consisting of Na, Li, Ca, Mg, and Si; (ii) an electrolyte including an electrolyte salt which is a carboranyl salt and an electrolyte solvent; and (iii) an SEI layer disposed on a surface of the anode. When M is Na or Li, the carboranyl salt is M⁺[HCB₁₁H₁₁]⁻. When M is Ca or Mg, the carboranyl salt is M²⁺[HCB₁₁H₁₁]₂⁻. The SEI layer includes reduction products obtained by electrochemical reduction of the electrolyte solvent. For example, the carboranyl salt may be NaHCB₁₁H₁₁, LiHCB₁₁H₁₁, Ca[HCB₁₁H₁₁]₂, and/or Mg[HCB₁₁H₁₁]₂. For example, the anode may include metal Na, and the carboranyl salt may include NaHCBiiHii.

The SEI layer may include species with bonding type Na—O, C—H, C—O, C—C, or a mixture of two or more thereof. These species may derive from degradation of the electrolyte solvent and the cation of the carboranyl salt, but may not derive from degradation of the anion of the carboranyl salt (e.g., the carborane). In some embodiments, the reduction products of the SEI layer are H, C, and O.

A fluorine content of the reduction products of the SEI layer may be less than 5 wt. %, less than 4.5 wt. %, less than 4.0 wt. %, less than 3.5 wt. %, less than 3.0 wt. %, less than 2.5 wt. %, less than 2.0 wt. %, less than 1.5 wt. %, less than 1.0 wt. %, less than 0.5 wt. %, less than 0.4 wt. %, less than 0.3 wt. %, less than 0.2 wt. %, less than 0.1 wt. %, less than 0.05 wt. %, or less than 0.01 wt. %, relative to a total weight of the reduction products. In some embodiments, the reduction products of the SEI layer are free of fluorine.

The anode may further include an anode current collector. For example, the current collector may be a conductive foil. In some embodiments, the anode is disposed directly on the current collector. In some embodiments, the anode is formed in situ on the anode current collector via electrodeposition. The anode current collector may be Cu, Al, or an alloy or blend of Cu and Al.

Illustrative electrolyte solvents include diethylene glycol dimethyl ether (diglyme), triethylene glycol dimethyl ether (triglyme), tetraethylene glycol dimethyl ether (tetraglyme), 1,2-dimethoxyethane, 1,3-dioxolane, dimethyl carbonate, ethyl methyl carbonate, diethyl carbonate, ethylene carbonate, propylene carbonate, tetrahydrofuran (THF), or a combination of two or more thereof. In some embodiments, the electrolyte solvent is diglyme, triglyme, and/or tetraglyme. In some embodiments, the electrolyte solvent is diglyme.

The carboranyl salt may be present in the electrolyte in a concentration of 0.1 M to 4 M, 0.2 M to 3.5 M, 0.3 M to 3 M, 0.4 M to 2.75 M, 0.5 M to 2.5 M, 0.6 M to 2.25 M, 0.7 M to 2 M, 0.8 M to 1.75 M, 0.85 M to 1.5 M, 0.9 M to 1.25 M, or 1 M to 1.1 M, relative to a total volume of the electrolyte. In some embodiments, the carboranyl salt is present in the electrolyte in a concentration of about 0.9 M, relative to a total volume of the electrolyte.

Metallic Na in/on the anode may be in the form of a thin film and/or microparticles having a spherical or substantially spherical structure (e.g., oval or oblong shape). In some embodiments, metallic Na of the anode is in the form of microparticles having a largest dimension from 0.1 μm to 10 μm, from 0.1 μm to 10 μm, from 0.2 μm to 9 μm, from 0.3 μm to 8 μm, from 0.4 μm to 7 μm, from 0.5 μm to 6 μm, from 0.6 μm to 5 μm, from 0.7 μm to 4 μm, from 0.8 μm to 3 μm, from 0.9 μm to 2 μm, from 1.0 μm to 1.75 μm, or from 1.25 μm to 1.5 μm.

The metallic Na of the anode may be substantially free of a dendritic structure, even after repeated electrochemical cycling. For instance, less than 0.1 wt. %, less than 0.01 wt. %, less than 0.001 wt. %, or about 0 wt. % of metal Na of the anode may be in the form of a dendritic structure.

In aspect, a battery system is provided that includes any of the anodes disclosed herein and a cathode.

Electrolytes

Another aspect is directed to an electrolyte, comprising: (i) an electrolyte salt which is a carboranyl salt; and (ii) an electrolyte solvent. The carboranyl salt may include a carborane anion that is a BRN. The BRN may not include any C—C bonds. The BRN may feature one vertex where B is replaced with a carbon nuclei. For example, the carborane anion may include HCB₁₁H₁₁⁻.

The carboranyl salt may be M⁺[HCB₁₁H₁₁]⁻ when M is Na or Li, and the carboranyl salt may be M²⁺[HCB₁₁H₁₁]²⁼ when M is Ca or Mg. For example, the carboranyl salt may be NaHCB₁₁H₁₁, LiHCB₁₁H₁₁, Ca[HCB₁₁H₁₁]₂, and/or Mg[HCB₁₁H₁₁]₂. For example, the carboranyl salt may be NaHCB₁₁H₁₁.

The electrolyte may have substantially few fluorine species, or be entirely free of fluorine species. Reducing or excluding fluorine species may provide longer cycling life and coulombic efficiency by mitigating or eliminating deleterious side-reactions involving the fluorine species and unstable SEI components. For example, the electrolyte may be free of conventional fluorine additives, including fluoroethylene carbonate (FEC). In some embodiments, the solvent may include less than 5 wt. %, less than 4.5 wt. %, less than 4.0 wt. %, less than 3.5 wt. %, less than 3.0 wt. %, less than 2.5 wt. %, less than 2.0 wt. %, less than 1.5 wt. %, less than 1.0 wt. %, less than 0.5 wt. %, less than 0.4 wt. %, less than 0.3 wt. %, less than 0.2 wt. %, less than 0.1 wt. %, less than 0.05 wt. %, or less than 0.01 wt. % of fluorine species relative to a total weight of the electrolyte. For example, the electrolyte may be free of fluorine species.

In any embodiment, the electrolyte solvent may be any of those described herein.

The carboranyl salt may be present in the electrolyte at a concentration of 0.1 M to 4 M, 0.2 M to 3.5 M, 0.3 M to 3 M, 0.4 M to 2.75 M, 0.5 M to 2.5 M, 0.6 M to 2.25 M, 0.7 M to 2 M, 0.8 M to 1.75 M, 0.85 M to 1.5 M, 0.9 M to 1.25 M, or 1 M to 1.1 M, relative to a total volume of the electrolyte. In some embodiments, the carboranyl salt is present in the electrolyte in a concentration of about 0.9 M, relative to a total volume of the electrolyte.

Methods

In another aspect, a method is provided for fabricating the anode. The method may include forming the anode in-situ on an anode current collector via electrodeposition. The method may include (i) providing the anode current collector; (ii) providing the electrolyte in contact with the anode current collector; (iii) plating the metal or metalloid M (e.g., Na, Li, Ca, Mg, and Si) on the anode current collector via electrodeposition to form the anode in situ; and (iv) reducing the electrolyte solvent via electrochemical reduction to form the reduction products of the SEI layer. The SEI layer may be deposited on a surface of the anode. The electrolyte may include an electrolyte salt (e.g., a carboranyl salt) and an electrolyte solvent (e.g., an organic solvent).

In any embodiment, the electrolyte may include any of the electrolytes described herein, and the cation in the electrolyte salt may be the metal or metalloid M plated on the anode current collector via electrodeposition to form the anode in situ.

Plating may be conducted at a current density of about 0.5 mA/cm² to about 2.0 mA/cm² (e.g., 0.5 mA/cm², 0.75 mA/cm², 1.0 mA/cm², 1.25 mA/cm², 1.50 mA/cm², 1.75 mA/cm², or 2.0 mA/cm²). Plating may be conducted with a polarization less than 40 mV, less than 35 mV, less than 30 mV, less than 25 mV, less than 20 mV, less than 15 mV, less than 10 mV, or less than 5 mV.

Plating may result in metallic or metalloid M in the form of a thin film and/or microparticles having a spherical or substantially spherical structure (e.g., oval or oblong shape) disposed on the current collector. In some embodiments, the metallic or metalloid M of the anode is in the form of microparticles having a width ranging from 0.1 μm to 10 μm, from 0.1 μm to 10 μm, from 0.2 μm to 9 μm, from 0.3 μm to 8 μm, from 0.4 μm to 7 μm, from 0.5 μm to 6 μm, from 0.6 μm to 5 μm, from 0.7 μm to 4 μm, from 0.8 μm to 3 μm, from 0.9 μm to 2 μm, from 1.0 μm to 1.75 μm, or from 1.25 μm to 1.5 μm. In some embodiments, the metallic or metalloid M of the anode is in the form of a thin film having a thickness of about 1 μm to about 20 μm (e.g., 1 μm to 15 μm, 5 μm to 12 μm, or about 10 μm).

The metallic or metalloid M of the anode may be substantially free of any dendritic structures, even after repeated electrochemical cycling. For instance, less than 0.1 wt. %, less than 0.01 wt. %, less than 0.001 wt. %, or about 0 wt. % of metallic or metalloid M of the anode may be in the form of a dendritic structure.

In any embodiment, the current collector may be a conductive foil. In some embodiments, the plated metallic or metalloid M of the anode is disposed directly on the current collector. The anode current collector may include Cu, Al, or both Cu and Al.

Following formation of the plated metallic or metalloid M, the SEI layer is formed on the surface of the plated metallic or metalloid M. In some embodiments, the SEI layer may form upon contact of the metallic or metalloid M with the electrolyte via spontaneous chemical reduction. The spontaneous chemical reduction may be sufficient for stable SEI generation. In some embodiments, the SEI layer may form via electrochemical reductive decomposition of the solvent. The mechanism of SEI formation may be dependent upon the chemical inertness of the carbonyl salt in the electrolyte and reaction between the metallic or metalloid M and the organic solvent. The mechanism of SEI formation may not include any or substantially any decomposition of the carbonyl salt's anion.

The SEI layer is made of reduction products of the electrolyte solvent and is free of or substantially free of degradation products derived from dissolved anions of the electrolyte salt. The resulting SEI layer may include species with bonding type Na—O, C—H, C—O, C—C, or a mixture of two or more thereof. These species may derive from degradation of the electrolyte solvent and the cation of the carboranyl salt, but may not derive from degradation of the anion of the carboranyl salt (i.e., the carborane anion). In some embodiments, the reduction products of the SEI layer consist essentially of H, C, and O. In some embodiments, the reduction products of the SEI layer consist of H, C, and O.

The SEI layer may have a fluorine content less than 5 wt. %, less than 4.5 wt. %, less than 4.0 wt. %, less than 3.5 wt. %, less than 3.0 wt. %, less than 2.5 wt. %, less than 2.0 wt. %, less than 1.5 wt. %, less than 1.0 wt. %, less than 0.5 wt. %, less than 0.4 wt. %, less than 0.3 wt. %, less than 0.2 wt. %, less than 0.1 wt. %, less than 0.05 wt. %, or less than 0.01 wt. %, relative to a total weight of the reduction products. In some embodiments, the SEI layer is free of fluorine.

Another aspect is directed to a method of manufacturing the electrolyte. The method comprises mixing the electrolyte salt, which is a carboranyl salt, and the electrolyte solvent, thereby forming the electrolyte. The carboranyl salt is M⁺[HCB₁₁H₁₁]⁻ where M is Na or Li, and the carboranyl salt is M²⁺[HCB₁₁H₁₁]²⁻ where M is Ca or Mg. For example, the carboranyl salt may be NaHCB₁₁H₁₁, LiHCB₁₁H₁₁, Ca[HCB₁₁H₁₁]₂, and/or Mg[HCB₁₁H₁₁]₂. For example, the carboranyl salt may be NaHCB₁₁H₁₁.

The method of manufacturing the electrolyte may include dissolving the carboranyl salt in the electrolyte solvent. The electrolyte solvent may be any electrolyte solvent disclosed herein. The carboranyl salt may be dissolved in the electrolyte solvent at a concentration of 0.1 M to 4 M, 0.2 M to 3.5 M, 0.3 M to 3 M, 0.4 M to 2.75 M, 0.5 M to 2.5 M, 0.6 M to 2.25 M, 0.7 M to 2 M, 0.8 M to 1.75 M, 0.85 M to 1.5 M, 0.9 M to 1.25 M, or 1 M to 1.1 M, relative to a total volume of the electrolyte. In some embodiments, the carboranyl salt is dissolved in the electrolyte in a concentration of about 0.9 M, relative to a total volume of the electrolyte.

The present invention, thus generally described, will be understood more readily by reference to the following examples, which are provided by way of illustration and are not intended to be limiting of the present invention.

### EXAMPLES

### Example 1

Herein, an example of an electrolyte including a carboranyl salt is reported that provides favorable operation of batteries with sodium metal anodes at >99.5% coulombic efficiency with exceptional long-term cycling stability. Extensive characterization of the electrolyte revealed solvent separated ion pairs and an anomalous distribution of anions dominating the electrolyte's in situ solvation structure. Consistent with electrochemical performance, characterization of the electrode surface revealed no evidence of dendritic sodium metal nucleation over prolonged cycling. Interestingly, X-ray photoelectron spectroscopy (XPS) characterization of the SEI on the anode revealed negligible boron species contribution to the SEI. Instead, XPS indicated that the SEI was made of organic species. Detailed characterization of the electrolytes in situ solvation structure indicated that the anion's reductive stability and the weakly coordinating properties, rather than fluorine-containing interphasial components, contribute to highly reversible sodium metal anodes.

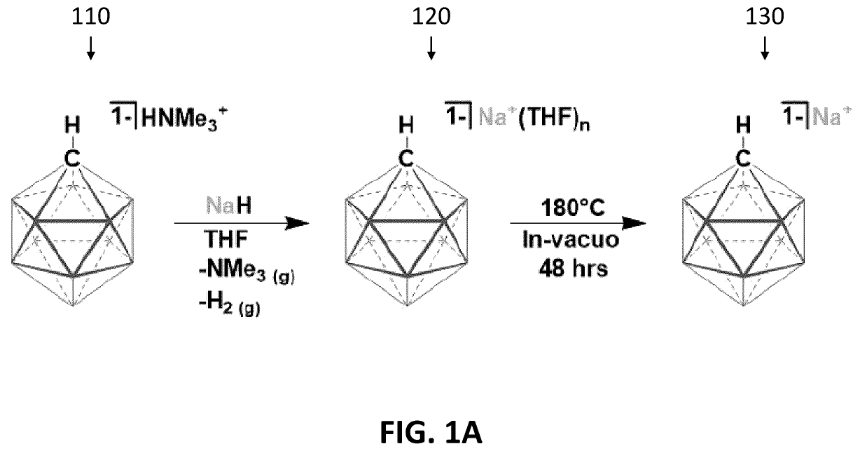

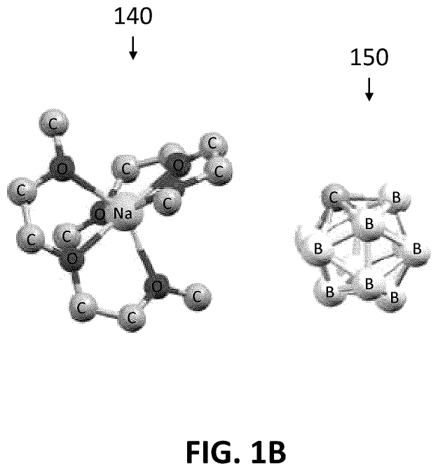

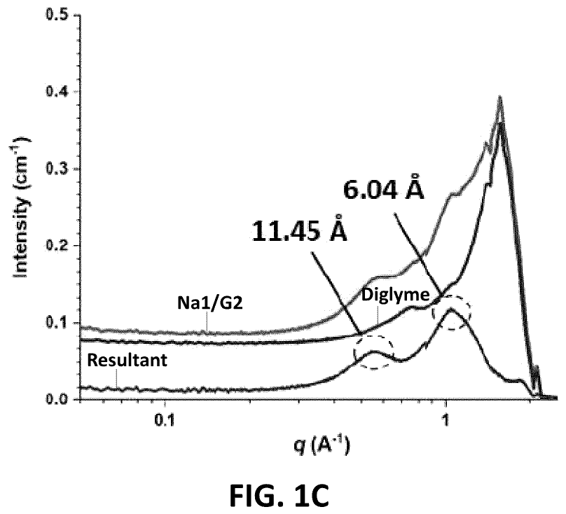

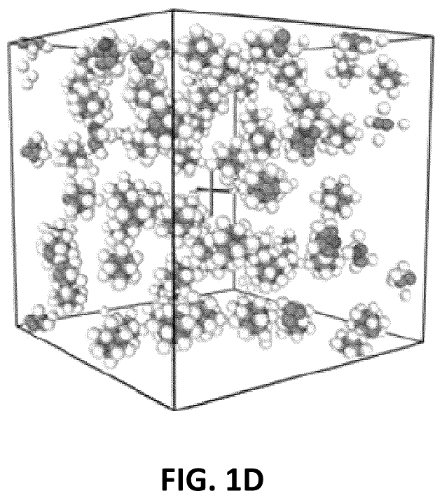

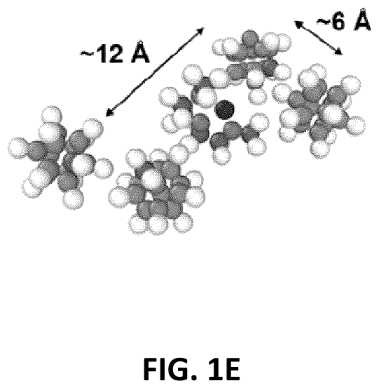

FIG. 1A is an illustration of the synthesis of and preparation of NaHCB₁₁H₁₁ 130 via deprotonation of HNMe⁺[HCB₁₁H₁₁]⁻ 110 with NaH. NaHCB₁₁H₁₁ 130 was prepared via reaction of HNMe⁺[HCB₁₁H₁₁]⁻ 110 with NaH in tetrahydrofuran (THF). CsHCB₁₁H₁₁ was prepared from decaborane (B₁₀H₁₄) which was sublimed prior to use. HNMe₃⁺[HCB₁₁H₁₁]⁻ 110 was prepared by dissolution of CsHCB₁₁H₁₁ in warm water followed by the addition of NMe₃ HCl, and the solid was collected via vacuum filtration. HNMe₃⁺[HCB₁₁H₁₁]⁻ 110 was dried for 12 hours in vacuo at 170° C. Working in a glovebox, HNMe₃⁺[HCB₁₁H₁₁]⁻ 110 was dissolved in THF and NaH was slowly added to the stirring solution until the effervescence of NMe₃ and H₂ stopped. The solution was filtered twice through a Whatman GF/A grade glass microfiber filter to remove excess NaH, resulting in [Na]⁺(THF)ₙ[HCB₁₁H₁₁]⁻ 120. The resulting clear solution was dried in-vacuo to yield NaHCB₁₁H₁₁ 130 as a white powder. The powder was further dried for 48 hours at 180° C. and stored in a PTFE-sealed flask prior to use. In contrast to typical salt metathesis methodology, the synthetic strategy employed here produced only gaseous biproducts yielding NaHCB₁₁H₁₁ 130 free of simple salt impurities. Following a desolvation procedure in which excess and coordinated solvent was removed, dry NaHCB₁₁H₁₁ 130 was deemed sufficient for electrolyte formulation.

FIG. 1B is an illustration of the molecular structure of NaHCB₁₁H₁₁ dissolved in diglyme as determined by single crystal X-ray diffraction analysis (with hydrogen omitted for clarity). The solubility of NaHCB₁₁H₁₁ in diglyme is limited to about 0.93 M. Solutions of 0.9 M NaHCB₁₁H₁₁ dissolved in diglyme were prepared for this study as the electrolyte. Anhydrous diethylene glycol dimethyl ether (diglyme) was purchased from Sigma Aldrich (99.5%) and dried over 3 Å molecular sieves prior to use. NaHCB₁₁H₁₁ (896 mg, 5.4 mmol) was added to diglyme (6 mL) and stirred for 12 hours resulting in a transparent yellow solution (0.9 M). The resulting electrolyte was used without further purification. As revealed by multi-nuclear NMR spectroscopy and mass spectrometry (QTOF-MS), NaHCB₁₁H₁₁ was of sufficient purity to explore electrochemical applications.

FIG. 1B is an illustration of the molecular solvation structure of NaHCB₁₁H₁₁ dissolved in diglyme as determined by single crystal X-ray diffraction analysis (with hydrogen omitted for clarity). The solvation structure showed significant dissociation of ions in NaHCB₁₁H₁₁ dissolved in diglyme. The results indicated that the electrolyte may consist of discrete [Na(diglyme)ₙ]⁺complexes 140 and carborane anions 150.

Synchrotron Small Angle X-ray Scattering (SAXS) experiments were undertaken in parallel with molecular dynamics simulations to characterize the in situ solvation structure of NaHCB₁₁H₁₁ dissolved in diglyme. Two peaks observed in the high q region suggested anion orientation into two relative environments, which were predominantly anion-anion separation distances of 6.04 Å and 11.5 Å (FIGS. 1C and 1D). The anion-anion center of mass radial distribution function from the simulation trajectory is in good agreement with distances derived from SAXS data, and also displayed peaks centered at 6 Å and 12 Å. FIG. 1E is a simulation snapshot from molecular dynamics simulations. Without being bound by any theory, the first peak at 6 Å may correspond to anions nearest others with no solvent between them, resulting in small anion-anion aggregates. Without being bound by any theory, the second peak at 12 Å may arise from long-range interactions near the expected anion separation distance for a homogenous distribution of NaHCB₁₁H₁₁ in a 0.9 M diglyme solution (FIG. 1E). Previously, it was thought that a 6 Å separation between carboranes may be explained by ion-paired species in-solution despite the relatively dilute concentration of the electrolyte. However, without being bound by any theory, computational modeling indicated NaHCB₁₁H₁₁ dissolved in diglyme contained less than 1% abundance of Na⁺-carborane contact ion pair (CIP) species. Na⁺ solvation in NaHCB₁₁H₁₁ dissolved in diglyme overwhelmingly favored solvent-separated ion pair (SSIP) species in over 99% abundance. These computational models were in agreement with calculated formation enthalpies of the species. A solid-state crystal structure of the electrolyte indicated the closest interaction between a saturated Na⁺ complex, [Na(diglyme)₂]⁺, and carboranyl B-H was 4.945 Å, indicating significant dissociation of ions in NaHCB₁₁H₁₁ dissolved in diglyme (FIG. 1B). Without being bound by any theory, the results indicated that the electrolyte may consist of discrete Na(diglyme)ₙ]⁺complexes and carborane anions that appear to be distributed inhomogeneously in solution. The lack of strong ion-pairing interactions and tendency for bulky [HCB₁₁H₁₁]⁻ anions to be forced in closer proximity may contribute to the high ionic conductivity (7.58 mS·cm⁻¹ at 25° C.) of NaHCB₁₁H₁₁ dissolved in diglyme, which increased significantly at elevated temperatures up to about 85° C. (about 14 mS·cm⁻¹ at 85° C.).

Symmetric and asymmetric 2032 coin cells were prepared to perform electrochemical tests. The bulk Na metal (Sigma Aldrich, 99.9%) was rolled into a foil and punched into discs with a diameter of 14 mm. Identical Na metal electrodes were used as the working electrode and counter electrode. Glass fiber filters (Whatman, F grade) were used as a separator and coin cells were assembled in an argon-filled glove box (>0.5 ppm H₂O, >0.5 ppm O₂). The galvanostatic charge-discharge cycling tests were performed by a battery cycler system connected to a coin cell climate chamber, which was set at 30° C.

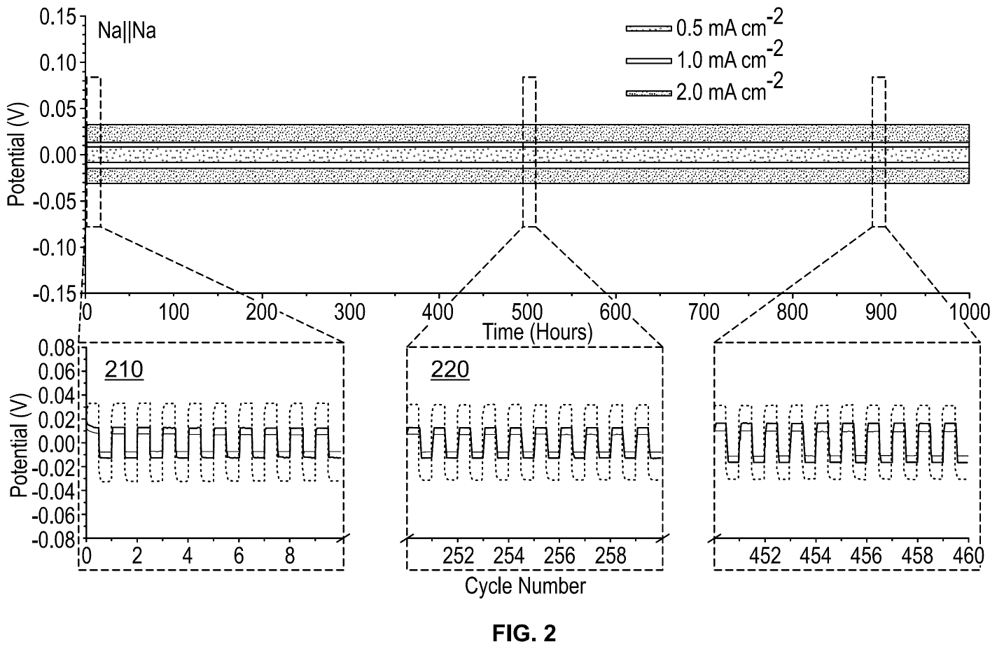

FIG. 2 is a graph of galvanostatic cycling of Na—Na symmetrical cells assembled with NaHCB₁₁H₁₁ dissolved in diglyme electrolyte at varying current densities and 1.0 mAh cm⁻² areal capacity. Inset 210 displays early cycle life voltage hysteresis and inset 220 displays voltage hysteresis beyond 450 cycles. Symmetrical Na—Na electrochemical cells with an electrolyte of 0.9 M NaHCB₁₁H₁₁ dissolved in diglyme were assembled to evaluate the deposition and dissolution processes at the sodium metal anode over time in this electrolyte. Symmetric cell behavior provides a convenient means to evaluate the chemical and electrochemical compatibility of the electrolyte with sodium metal. Cells were operated under current densities ranging from 0.5 mA cm⁻² to 2.0 mA cm⁻² at a constant areal capacity of 1.0 mAh cm⁻². The Na—Na cell with the electrolyte of NaHCB₁₁H₁₁ dissolved in diglyme demonstrated a steady polarization of less than 10 mV in response to a modest current density of 0.5 mA cm⁻² (FIG. 2). This potential was maintained from the onset of cycling to well beyond 1000 hours of operation, suggesting the formation of a highly stable passivating SEI layer. The electrochemical cells were not conditioned prior to demonstrating low potential response, suggesting the spontaneous chemical reduction of NaHCB₁₁H₁₁ dissolved in diglyme is sufficient for stable SEI formation. The mechanism through which the sodium metal anode was chemically passivated on contact with the electrolyte may depend on the chemical inertness of NaHCB₁₁H₁₁ and reaction between sodium metal and diglyme. Here, little if any active material was consumed upon initial cycling of a pristine cell, as indicated by the high first cycle coulombic efficiency described below. Symmetrical cell performance was also evaluated at higher current density. Over the same period of time, Na—Na cells cycled at 1.0 mA cm⁻² and 2.0 mA cm⁻² displayed a consistent, higher potential response of 15 mV and 32 mV, respectfully (FIG. 2). Symmetric cells operated at an even higher current density of 4.0 mA cm⁻² maintained an average potential response of 37.2 mV. However, the cell cycled at 4.0 mA cm⁻² displayed lower cycling stability than the cells cycled at lower current densities.

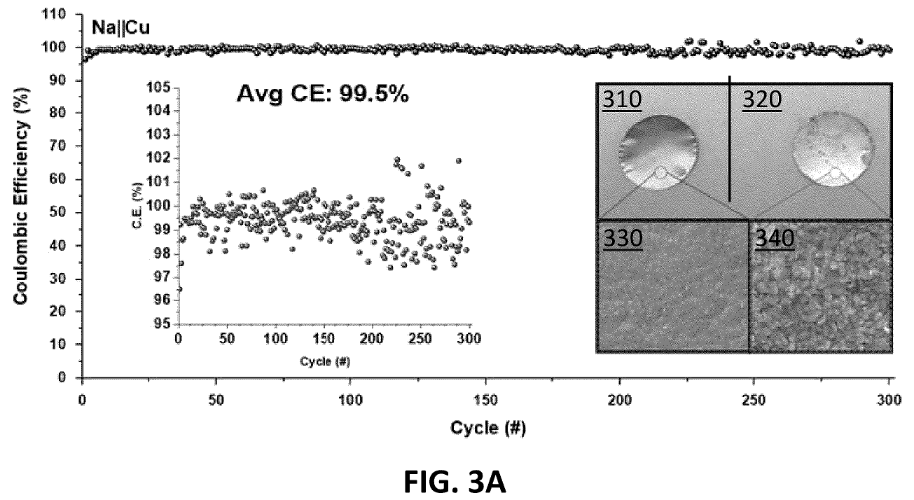

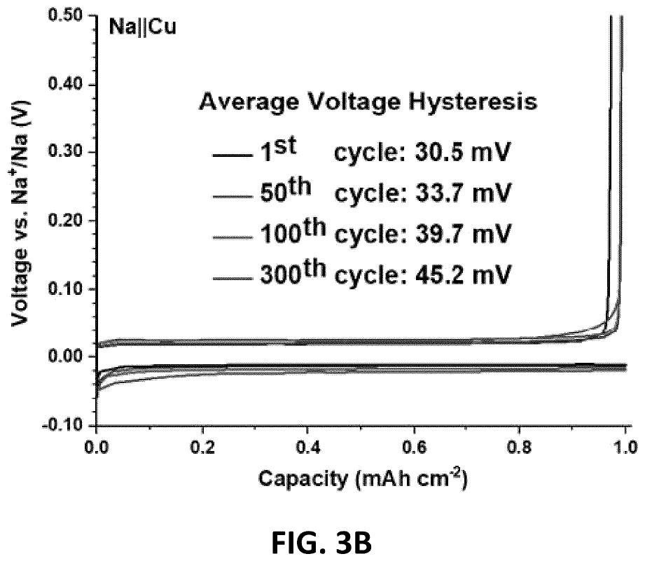

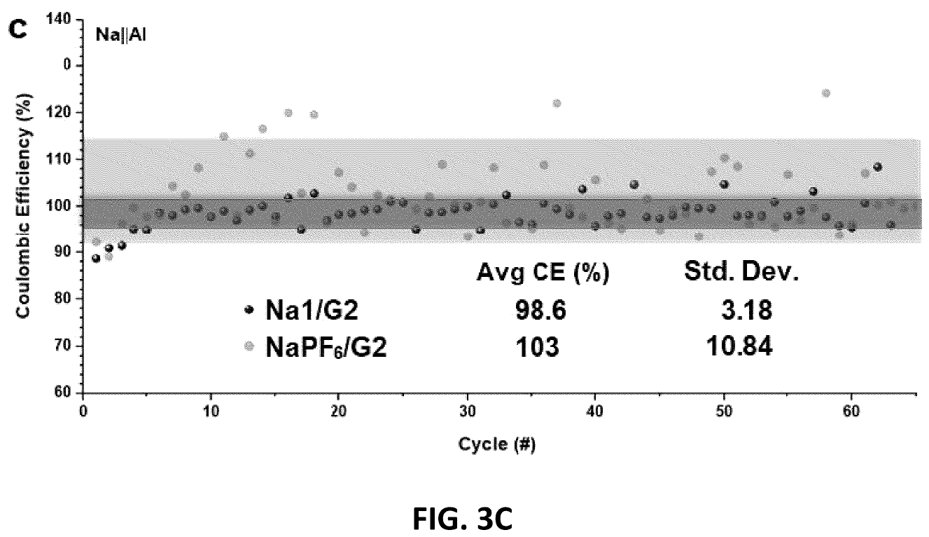

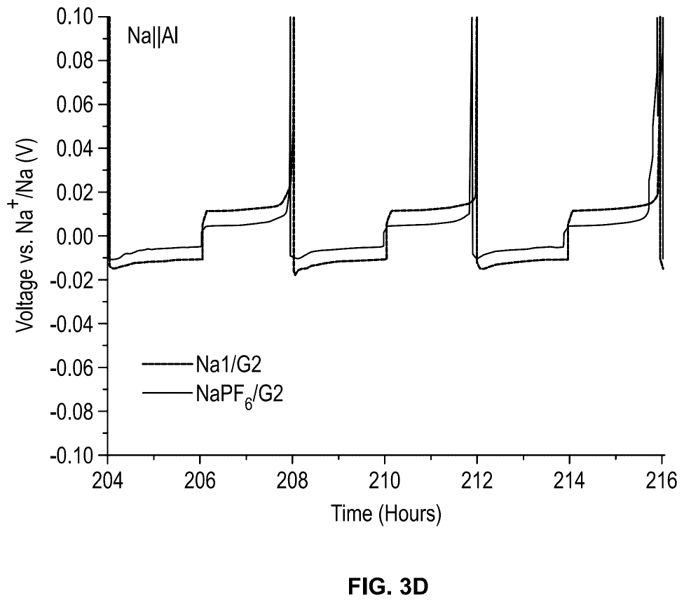

Na—Cu and Na—Al half cells with an electrolyte including 0.9 M NaHCB₁₁H₁₁ dissolved in diglyme were assembled to evaluate sodium plating and stripping processes on bare current collectors. These half cells provide insight into incorporating electrolyte including NaHCB₁₁H₁₁ dissolved in diglyme into practical so-called “anode-free” cell architectures, which are assembled without a dedicated anode active material. To this end, the copper and aluminum current collectors were not subjected to surface treatment or engineering. The Na—Cu half-cell demonstrated a first cycle coulombic efficiency of 96.5% followed by 99.2% in the second cycle, indicating little conditioning of the electrode surface to achieve highly efficient metal electrodeposition (FIG. 3A). An average coulombic efficiency of 99.8% was maintained over the first 100 cycles, and an average coulombic efficiency of 99.5% was maintained over 300 cycles, indicating the highly reversible sodium electrodeposition processes in this electrolyte. Similar to the results of symmetrical cell experiments, the half-cell experiments demonstrated a low voltage hysteresis, which may be related to the sodium deposition and stripping behavior on the copper electrode (FIG. 3B). The voltage hysteresis over prolonged cycling gradually increased from 30.5 mV in the first cycle to 45.2 mV over the subsequent 300 cycles. Here, the gradual, albeit modest, increase in potential corresponded with reduced average coulombic efficiency (FIGS. 3A and 3B). Without being bound by any theory, this behavior may arise from repeated in situ formation of a fresh sodium metal surface on the copper electrode, chemical reduction of diglyme, and an increase in internal cell resistance over time as solvent is consumed. Disassembled half-cells following the deposition process revealed a homogenous layer of sodium metal that displayed a characteristic metallic sheen, suggesting minimal side reactions occurred between the electrolyte and deposited sodium metal (FIG. 3A inset).

Anode-free SIBs using aluminum current collectors offered an energetically dense, economical alternative to copper. Electrochemical experiments using Na—Al half cells used the same conditions as were used for experiments with Na—Cu half cells. Electrochemical cycling of Na—Al half cells with electrolyte including NaHCB₁₁H₁₁ dissolved in diglyme demonstrated a high coulombic efficiency of 98.6%. For comparison, cells using an electrolyte including 1.0 M NaPF₆ in diglyme exhibited an erratic discharge capacity and poor cycling stability, highlighted by a large standard deviation in coulombic efficiency (FIG. 3C). Consequently, the slightly lower overpotential exhibited by the cell using an electrolyte including 1.0 M NaPF₆ in diglyme during cycling was overshadowed by its poor electrochemical performance, perhaps due to incompatibility with the current collector (FIG. 3D). In contrast, the high chemical and electrochemical stability of [HCB₁₁H₁₁]⁻ if may prevent or substantially deter deleterious side reactions with aluminum, indicating electrolyte with NaHCB₁₁H₁₁ dissolved in diglyme may be a promising candidate for anode-free cell electrolytes.

The electrochemical performance observed from Na—Cu and Na—Al half cells with electrolyte with NaHCB₁₁H₁₁ dissolved in diglyme implies the absence of common failure mechanisms, such as dendritic sodium nucleation, associated with sodium metal anodes. Additionally, the high coulombic efficiency suggests the occurrence of favorable sodium metal deposition-dissolution processes on the copper electrode useful for anode-free cells.

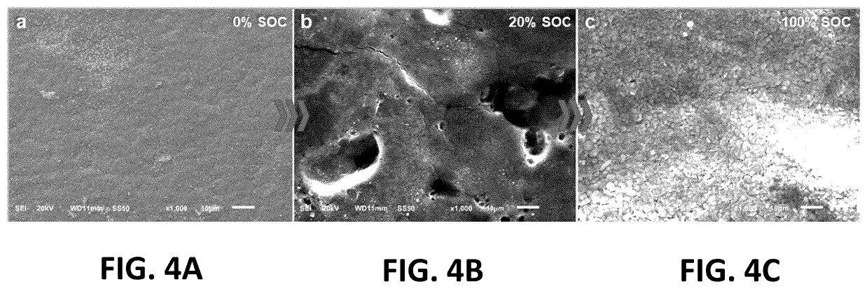

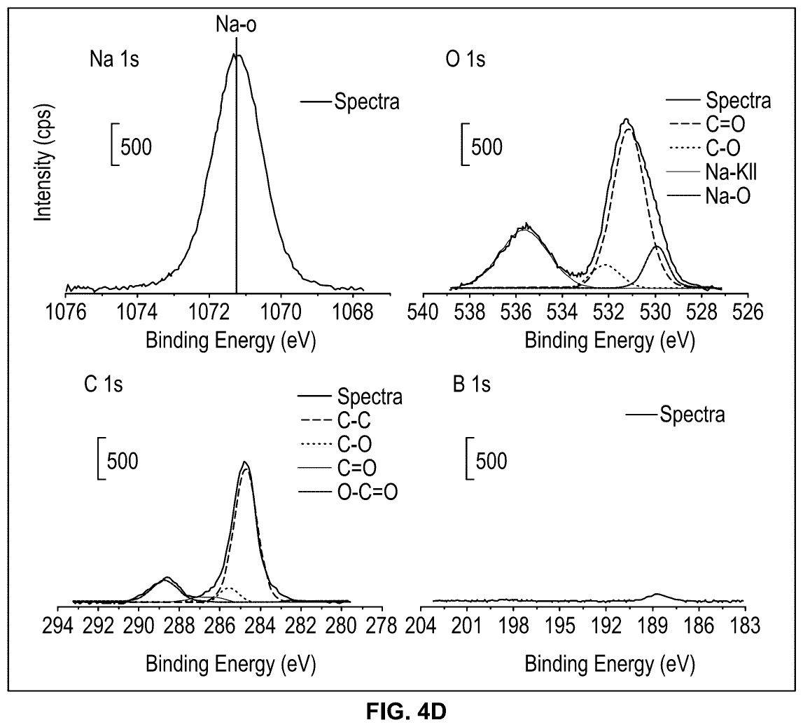

Sodium metal nucleation with electrolyte with NaHCB₁₁H₁₁ dissolved in diglyme was characterized via scanning electron microscopy (SEM) and energy dispersive X-ray spectroscopy (EDS) mapping. Sodium metal nucleation at progressive state-of-charge (SOC) was examined to reveal time-dependent sodium electrodeposition processes. Imaging showed no surface abnormalities indicative of dendritic sodium deposits (FIGS. 4A-4C). The absence of dendritic sodium nucleation is consistent with the exceptional cycling stability and steady coulombic efficiency observed in Na—Cu half cells. At 20% SOC (0.2 mAh cm⁻²) a uniform, thin layer of sodium metal was deposited on the surface of the copper electrode (FIG. 4B). In the fully charged state, (1.0 mAh cm⁻²) a similarly homogenous sodium metal deposition was observed (FIG. 4C). Upon closer observation, it was revealed that the deposited sodium metal at 100% SOC was comprised of small spherical deposits ranging from 0.5 μm to 2 μm in width. Isolated regions of flat sodium metal deposition at 20% SOC hosted small quantities of similar Na deposits. Sodium metal nucleation in electrolyte with NaHCB₁₁H₁₁ dissolved in diglyme thus progressed first through a flat deposition of sodium metal on the copper substrate followed by a spherical morphology on the surface of the in-situ formed sodium metal anode. Without being bound by any theory, the seemingly evolving morphology may result from competitive processes of diglyme reduction and deposition of Na metal on the in-situ generated sodium surface. Similar sodium morphology was observed in half cells after 35 electrochemical cycles, though the spherical structures observed after 1 cycle appeared to merge, forming both plate-like structures as well as regions of dense, low surface area sodium metal deposits. This morphological evolution of the sodium metal deposition may be related to the modest increase in voltage hysteresis over extended cycling as diglyme is slowly consumed. Nevertheless, the high half-cell coulombic efficiency suggests minute solvent consumption has little bearing on the efficiency of reversible electrochemical processes in the cell.

Subjecting NaPF₆ in diglyme to even slightly elevated temperatures above 25° C. (e.g., up to 85° C.) resulted in the generation of anion decomposition products, including HF. In comparison, NaHCB₁₁H₁₁ dissolved in diglyme resulted in substantially no decomposition products. The robust nature of [HCB₁₁H₁₁]⁻ mitigated or prevented the formation of anion-derived decomposition species in the electrolyte or resulting SEI layer. The SEI layer that formed on the sodium metal anode was comprised entirely or substantially from organic species resulting from the chemical reduction of diglyme. Following deposition of sodium metal on the copper current collector at a 1.0 mA cm⁻², the sodium metal anode and current collector were characterized using surface microscopy and XPS techniques. SEM images of the sodium metal anode revealed a homogenous surface dotted with crystalline microstructures less than 1.0 μm in width. EDS mapping of the surface indicated these surface features consisted primarily of sodium, oxygen, and carbon containing species, likely arising from reaction with diglyme. Minor changes in surface morphology were observed for a sodium metal anode cycled 35 times save for an increased quantity of dense sodium metal deposits that dotted the surface. XPS analysis of the surface revealed these species are comprised predominantly of Na—O, C—O, C—C, and C—H bonding interactions (FIG. 4D). A small quantity (about 2.8% relative abundance) of boron-containing species were detected on the surface which corresponded to B-H binding energies associated with pristine [HCB₁₁H₁₁]⁻, suggesting the maintenance of cluster integrity. The speciation of the SEI on the anode was maintained after 35 cycles with NaHCB₁₁H₁₁ dissolved in diglyme. This result indicated prolonged exposure and electrochemical cycling of cells with sodium metal and with an electrolyte of NaHCB₁₁H₁₁ dissolved in diglyme did not result in decomposition of [HCB₁₁H₁₁]⁻ or increased boron speciation. For sodium metal anodes generated in-situ via electrodeposition on a copper substrate in anode-free cells, a nearly identical SEI composition was also observed. Consistent with the synthesis and formulation of the electrolyte, there was no spectroscopic evidence indicating the SEI received contribution from [HCB₁₁H₁₁]⁻ or any inorganic species save for latent Na—O, and was derived solely from the diglyme solvent. Furthermore, significant ion-pairing in charge transport species did not appear to be a key design principle towards achieving stable sodium metal anodes.

In order to realize a transition to battery systems based on earth abundant elements, such as sodium, electrochemical cells that satisfy the high energy density, calendar life, and reliable safety offered by LIB s may be used. Ambient temperature anode-free sodium metal batteries may be a balanced choice in these aspects, providing highly efficient sodium metal deposition and stripping when used with an electrolyte of NaHCB₁₁H₁₁ dissolved in diglyme. Carboranes provide efficient anode-free cell architectures that can achieve upwards of 300 Wh kg⁻¹, a suitable energy density for transportation applications. The highly reversible nature of cells utilizing an electrolyte of NaHCB₁₁H₁₁ dissolved in diglyme can be credited to multiple factors including, without being bound by any theory, weak-ion pairing in-situ, non-dendritic Na metal nucleation, and an SEI free of anion reduction products and fluorine. These factors contradict the general narrative established around glyme-based sodium electrolytes as strong ion-pairing and fluorine-containing anions were previously thought essential to stabilize the sodium metal anode.

In summary, the present example explores the pairing of a non-fluorine-containing carboranyl electrolyte with pure sodium metal anodes, yielding highly reversible, dendrite-free cell cycling. SEI characterization and investigation of sodium metal deposition/stripping processes suggested the electrolyte presented herein was a candidate for anode-free cells. Specifically, realization of practical sodium metal batteries (SMBs) was previously hindered due to lack of compatible electrolyte components, dendrite propagation, and poor understanding of anodic interphasial chemistries. Chemically robust liquid electrolytes that facilitate both favorable sodium metal deposition and a stable solid-electrolyte interphase (SEI) are ideal to enable sodium metal and anode-free cells. Herein, a fluorine-free electrolyte utilizing the [HCB₁₁H₁₁]⁻ if anion was characterized as chemically robust, facilitating both favorably sodium metal deposition and stable SEI formation. Symmetrical Na cells operated with this electrolyte exhibited a remarkably low overpotential of 0.032 V at a current density of 2.0 mA cm⁻² and a high coulombic efficiency of 99.5% in half-cell configurations. Surface characterization of electrodes post-operation revealed the absence of dendritic sodium nucleation and a surprisingly stable fluorine-free SEI. Furthermore, weak ion-pairing was identified as contributing towards the successful development of fluorine-free sodium electrolytes.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions, or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

What is claimed is:

1. An anode in an electrochemical cell, comprising:
an anode active material comprising sodium; and
a solid electrolyte interphase (SEI) layer disposed on the anode active material, the SEI layer including reduction products of an electrolyte solvent and free of degradation products derived from dissolved anions of an electrolyte salt, wherein the electrolyte solvent and the electrolyte salt are present in an electrolyte of the electrochemical cell;
wherein the SEI layer does not comprise a fluorine content greater than 5 wt. %.

2. The anode of claim 1, wherein the SEI layer comprises species with bonding type Na—O, C—H, C—O, C—C, or a mixture of two or more thereof.

3. The anode of claim 1, wherein the sodium in the anode active material is present as a plurality of microparticles having widths of about 0.1 μm to about 10 μm.

4. The anode of claim 1, wherein the electrolyte salt comprises a carboranyl anion.

5. The anode of claim 4, wherein the carboranyl anion does not comprise a C—C bond.

6. The anode of claim 5, wherein the carboranyl anion comprises HCB₁₁H₁₁⁻.

7. The anode of claim 1, wherein the electrolyte solvent comprises diglyme, triglyme, tetraglyme, 1,2-dimethoxyethane, 1,3-dioxolane, dimethyl carbonate, ethyl methyl carbonate, diethyl carbonate, ethylene carbonate, propylene carbonate, tetrahydrofuran, or a mixture of two or more thereof.

8. An electrochemical cell comprising:
an anode comprising sodium;
an electrolyte comprising:
a solvent; and
a carboranyl salt;
wherein the carboranyl salt does not comprise a C—C bond.

9. The electrochemical cell of claim 8, further comprising a solid electrolyte interphase (SEI) layer disposed on the sodium, the SEI layer comprising species with bonding type Na—O, C—H, C—O, C—C, or a mixture of two or more thereof; and
wherein the SEI layer does not comprise a fluorine content greater than 5 wt. %.

10. The electrochemical cell of claim 8, wherein the carboranyl salt comprises HCB₁₁H₁₁⁻.

11. The electrochemical cell of claim 8, wherein the carboranyl salt is present in the electrolyte in a concentration of about 0.1 M to about 4 M.

12. The electrochemical cell of claim 8, wherein the electrolyte is free of fluorine.

13. The electrochemical cell of claim 8, wherein the solvent comprises diglyme, triglyme, tetraglyme, 1,2-dimethoxyethane, 1,3-dioxolane, dimethyl carbonate, ethyl methyl carbonate, diethyl carbonate, ethylene carbonate, propylene carbonate, tetrahydrofuran, or a mixture of two or more thereof.

14. The electrochemical cell of claim 8, further comprising an anode current collector,
wherein the sodium is present in the anode as a plurality of microparticles disposed on the anode current collector, the plurality of microparticles having widths of about 0.1 μm to about 10 μm.

15. A method of fabricating an anode, the method comprising:
plating sodium metal on an anode current collector via electrodeposition from an electrolyte comprising a carboranyl salt dissolved in an organic electrolyte solvent; and
forming a solid electrolyte interphase (SEI) layer on a surface of the sodium metal via electrochemical decomposition of the organic electrolyte solvent,
wherein forming the SEI layer does not include electrochemical decomposition of an anion of the carboranyl salt.

16. The method of claim 16, wherein the anion of the carboranyl salt does not comprise a C—C bond.

17. The method of claim 16, wherein the anion of the carboranyl salt comprises HCB₁₁H₁₁⁻.

18. The method of claim 16, wherein the carboranyl salt is present in the electrolyte in a concentration of about 0.1 M to about 4 M.

19. The method of claim 16, wherein the electrolyte is free of fluorine.
